(19) United States
(12) Patent Application Publication
(10) Pub. No.: US 2026/0080477 A1
(43) Pub. Date: Mar. 19, 2026

(54) BEI Behavioral Economic Identity Economic Sovereign Genesis Architecture , Domain Name as Information Energy Material with BEI Meter BEI Metre Dual Standard and Sovereign Conversion to BEIUSD BEICNY BEIEUR

(71) Applicant: FURONG BEI, SAN GABRIEL, CA (US)

(72) Inventor: FURONG BEI, SAN GABRIEL, CA (US)

(21) Appl. No.: 19/356,113

(22) Filed: Oct. 11, 2025

(51) Int. Cl. G06Q 40/06; G06Q 20/02; G06Q 20/38

(52) U.S. Cl. CPC G06Q 40/06; G06Q 20/023; G06Q 20/381

(57) ABSTRACT

A Behavioral-Economic-Identity (BEI) architecture is disclosed that treats Domain Name resources as an information-energy material implemented by a three-layer lattice comprising an identity layer, a tokenization layer, and a currency layer. A BEI-Meter quantizes lawful behavioral evidence into BEI units and mints standardized Time, Attention, and Credit instruments. Policy-gated by compliance couplers (BEISIGN/LDN/DM-Cert) and a compliance registry, mint outputs clear through a clearing/exchange frame (BEICX, BEISX, BEIGX) and settle via outbound sovereign interfaces into BEIUSD, BEICNY, and BEIEUR. The system originates from a 1999 multi-system domain ecosystem and provides measurable improvements in latency, failure rate, rollback control, and auditability, enabling a behavioral-energy internet suitable for standards-essential deployment and licensing.

### CROSS-REFERENCE TO RELATED APPLICATIONS

This application claims priority/benefit as a continuation-in-part (CIP) of the BEI family including U.S. Pub. Nos. 2025/0209946 A1, 2025/0259241 A1, 2025/0270286 A1, 2025/0265531 A1, and 2025/0219789 A1, each incorporated by reference to the extent permitted.

### INCORPORATION BY REFERENCE

All documents listed on the concurrently filed IDS (PTO/SB/08A-08B), including third-party references (e.g., Verisign—DNS, IBM—decentralized identity, Chainlink—oracle), are incorporated by reference for all purposes to the extent permitted.

### FIELD OF THE INVENTION

The disclosure relates to networked computing, digital identity, economic settlement, and financial infrastructure. More particularly, to a Behavioral-Economic-Identity (BEI) architecture that treats Domain Name resources as an information-energy material, enabling minting, compliance, clearing, and sovereign currency conversion across a behavioral-energy internet.

### BACKGROUND

Conventional internet stacks index information but do not natively measure, conserve, transmit or settle human behavioral economic energy. Payment networks remain siloed; compliance is after-the-fact; digital identity and economic value are decoupled; and domain names are treated as mere locators rather than active economic atoms. As a result, cross-border liquidity is fragmented, settlement is slow, and compliance/rollback is costly.

### ORIGIN

Beginning in 1999, the applicants systematized 2,000+ BEI domain ecosystems spanning people, families, industries, countries and time-domains, forming a multi-system, honeycomb lattice intended to host a behavioral-energy internet.

### SUMMARY OF THE INVENTION

Disclosed is an information-energy composite material (“BEI-Si”) implemented as a three-layer BEI economic material lattice (100) comprising an identity layer (110), a tokenization layer (120), and a currency layer (130). Domain Name nodes function as lattice atoms that: (i) generate BEI instruments—Time, Attention, Credit (171-173) in a minting zone (170); (ii) undergo policy gating via compliance couplers (131,132) and a compliance registry (181) in zone (180); and (iii) clear through a clearing/exchange frame (190) comprising BEICX (191), BEISX (192), and BEIGX (193). Outbound interfaces (196-199) convert into sovereign-grade instruments BEIUSD (215), BEICNY (216), BEIEUR (217).

The system further includes a BEI-Meter assembly (300) providing sensing (310), ledgering (312), unit calibration (320), mint interface (330), exchange interface (340), settlement interface (350), and emergency freeze/recovery (360). The architecture supports 100 ms netting windows, adaptive rollback, and policy-driven routing, yielding measurable improvements in latency, failure rate, and regulatory audibility.

### ADVANTAGES

The invention: (a) elevates domain names from passive locators to active BEI material; (b) unifies identity, minting, compliance and clearing; (c) enables programmable sovereign currency conversion with traceable BEI provenance; and (d) provides a path to standards-essential interfaces for BEI measurement, minting, and cross-network clearing.

### BRIEF DESCRIPTION OF THE DRAWINGS

FIG. 1—BEI End-to-End Chain (Labeled).

FIG. 2—BEI Economic Material Lattice (Labeled).

FIG. 3—BEI-Meter Assembly (Labeled).

FIG. 4—Minting, Compliance, and Paths to Clearing (Labeled).

FIG. 5—Clearing/Exchange Modalities (Labeled).

FIG. 6—Domain Production Chain (Labeled).

### DEFINITIONS

BEI (Behavioral-Economic-Identity): a machine-verifiable identity score/vector derived from lawful behavioral evidence and used as an energy unit for minting and clearing.
Information-Energy Material/BEI-Si: a computable material abstraction realized by the three-layer lattice (100).
BEI Instruments: Time, Attention, and Credit instruments (171-173) standardized for minting and settlement.
Compliance Couplers: mechanisms (131,132) including BEISIGN, LDN, and DM-Cert for pre-trade policy gating, OCSP-like status broadcast, and rollback orchestration.
Sovereign Interfaces: outbound interfaces (196-199) that convert cleared BEI value into BEIUSD/BEICNY/BEIEUR.

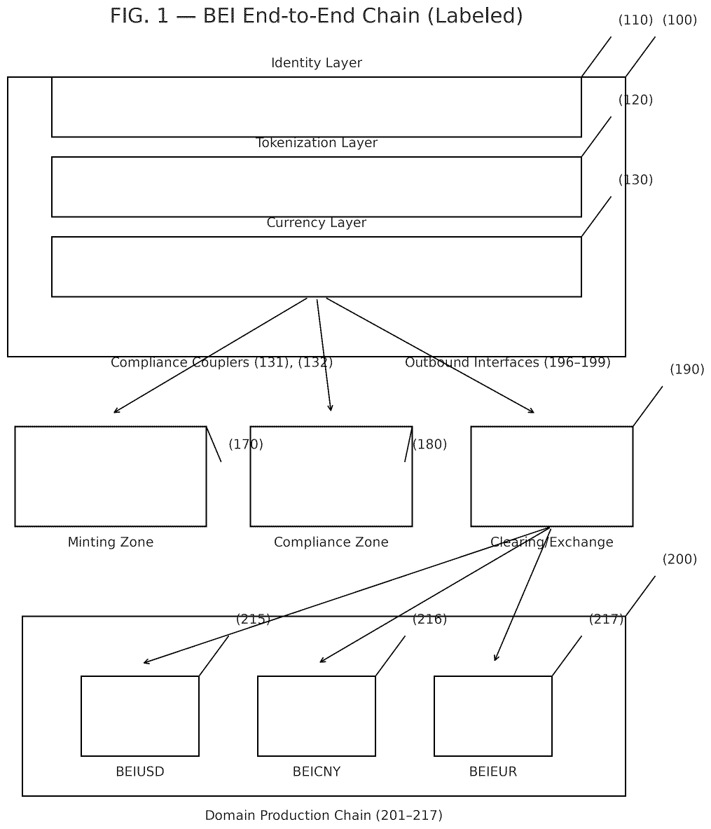

### System Overview (FIG. 1)

The lattice (100) houses layers (110/120/130). Output from (130) fans out via couplers (131,132) to zones: minting (170), compliance (180), and clearing (190). Cleared value flows through (196-199) into (215)/(216)/(217). The domain production chain (200) binds exemplar domains (201-214) for registration, tokenization, credit/title, securities, banking, and exchange operations.

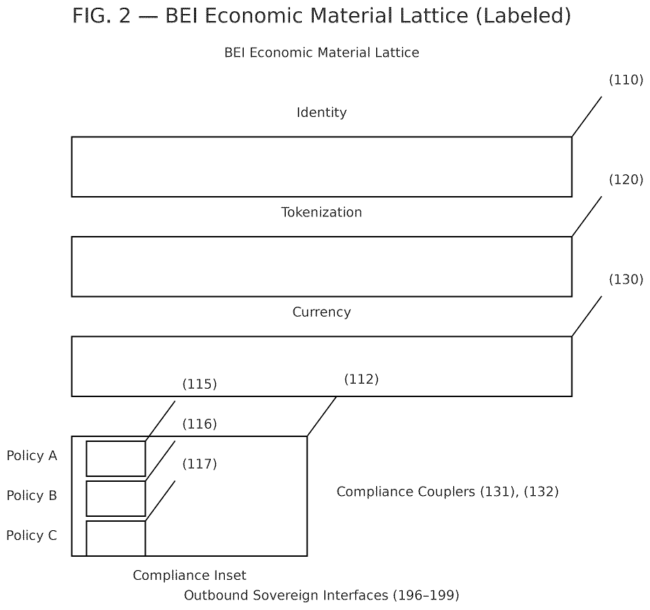

### Economic Material Lattice (FIG. 2)

Layer (110) maintains BEI identity graphs and keys; layer (120) hosts minting logic and token registries; layer (130) aggregates currency positions. The compliance inset (112) stores policy lists (115-117) referenced by couplers (131,132).

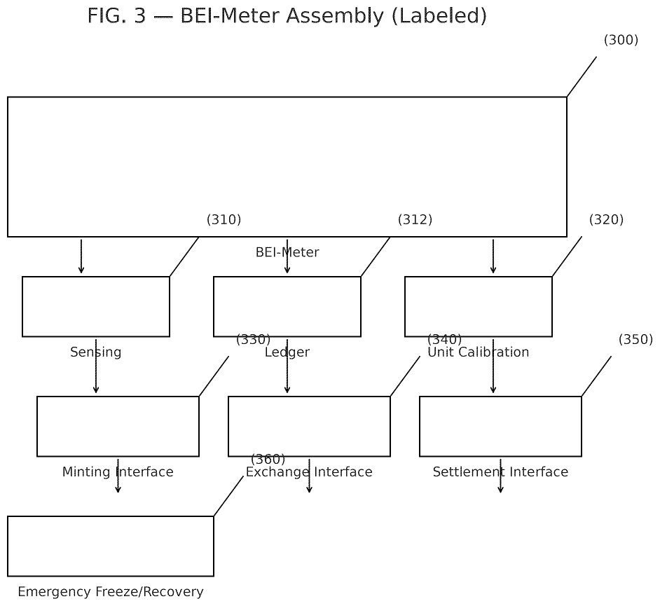

### BEI-Meter (FIG. 3)

Module (300) measures lawful behavioral events, normalizes them into BEI units, writes to an append-only ledger (312), calibrates units (320), invokes mint (330), and provides exchange (340) and settlement (350) interfaces. An emergency control (360) supports freeze/recovery by policy.

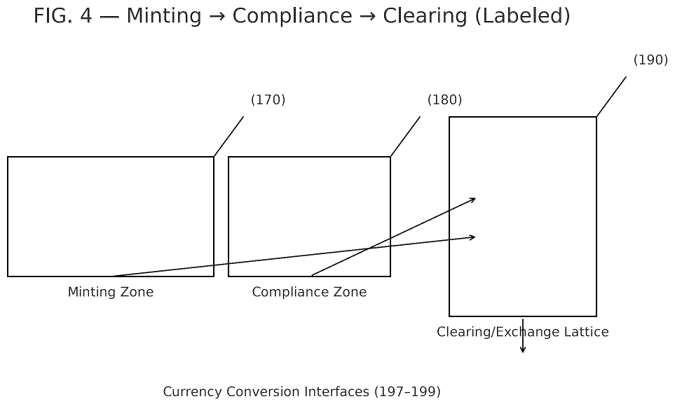

### Minting→Clearing Paths (FIG. 4)

Minting zone (170) standardizes Time/Attention/Credit (171-173); outputs pass through compliance registry (181) and enter clearing/exchange lattice (190), targeting BEICX/BEISX/BEIGX (191-193).

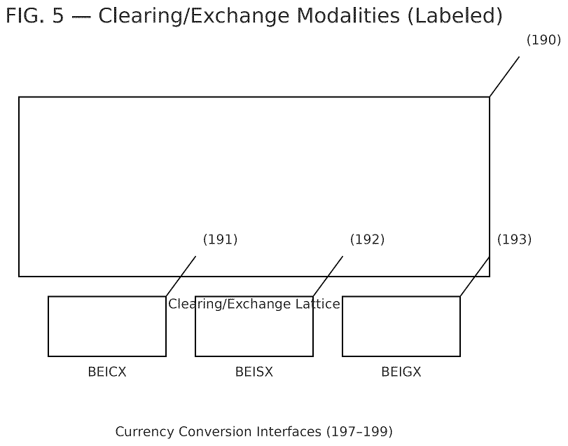

### Clearing Modalities (FIG. 5)

Frame (190) orchestrates segmented submission, netting across 100 ms windows, and circuit-breaker logic, then publishes settlement states to interfaces (197-199).

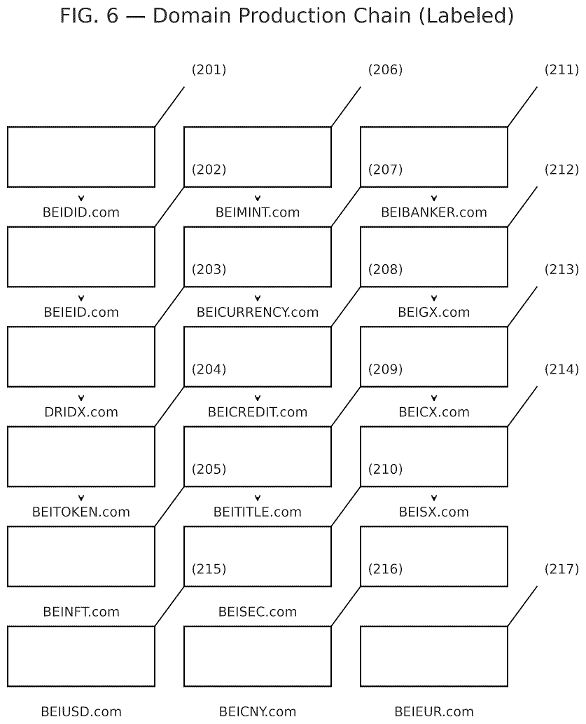

### Domain Production Chain (FIG. 6)

Illustrative domains: (201) BEIEID.com com, (202) BEICURRENCY.com, (203) DRIDX.com, (204) BEITOKEN.com com, (205) BEITITLE.com, (206) BEIMINT.com, (207) BEICREDIT.com, (208) BEICX.com, (209) BEISX.com, (210) BEIUSD.com, (211) BEIBANKER.com, (212) BEIGX.com, (213) BEISX. com (exchange route), (214) BEISEC.com, (215) BEIUSD.com (216), BEICNY.com, (217) BEIEUR.com. The chain is exemplary and non-limiting; an Appendix A may list additional BEI domain ecosystems.

### Implementation Notes

The system may be realized as distributed services, smart-contract platforms, or regulated financial market infrastructure. Interfaces provide verifiable audit trails suitable for regulatory reporting.

### Reference Numerals (Master List)

(100) lattice; (110) identity; (120) tokenization; (130) currency; (112) compliance inset; (115-117) policy lists; (131), (132) compliance couplers; (170) minting zone; (171-173) Time/Attention/Credit; (180) compliance zone; (181) compliance registry; (190) clearing/exchange frame; (191) BEICX; (192) BEISX; (193) BEIGX; (196-199) sovereign interfaces; (200) domain production chain; (201-217) exemplar domains; (215) BEIUSD; (216) BEICNY; (217) BEIEUR; (300) BEI-Meter; (310) sensing; (312) ledger; (320) calibration; (330) mint; (340) exchange; (350) settlement; (360) freeze/recovery.

1. A computer-implemented BEI economic material lattice (100) comprising: an identity layer (110) storing Behavioral-Economic-Identity records; a tokenization layer (120) configured to mint BEI instruments; a currency layer (130) aggregating positions; compliance couplers (131,132) coupled to a compliance registry (181); a clearing/exchange frame (190) comprising BEICX (191), BEISX (192), and BEIGX (193); and sovereign interfaces (196-199) operative to convert cleared value into BEIUSD (215), BEICNY (216), and BEIEUR (217).

2. A method of operating a behavioral-energy internet, comprising: receiving behavioral evidence; quantizing the evidence into BEI units via a BEI-Meter (300); minting Time, Attention, and Credit instruments (171-173) in a minting zone (170); performing policy gating through compliance couplers (131,132); clearing mint outputs through (190); and emitting settlement to (215), (216), (217) via (196-199).

3. A non-transitory computer-readable medium storing instructions that, when executed, cause processors to implement the steps of claim 2 and maintain state across the layers (110/120/130) with rollback and circuit-breaker logic.

4. The system of claim 1, wherein the BEI-Meter (300) includes sensing (310), ledgering (312), unit calibration (320), mint interface (330), exchange interface (340), and settlement interface (350).

5. The system of claim 1, wherein the compliance couplers (131,132) implement BEISIGN, LDN, and DM-Cert with OCSP-like broadcast.

6. The method of claim 2, wherein clearing uses 100 ms netting windows and segmented submission.

7. The method of claim 2, further comprising adaptive rollback based on dispute/volatility rates.

8. The system of claim 1, wherein Time/Attention/Credit (171-173) instruments are standardized for sovereign conversion.

9. The system of claim 1, wherein the domain production chain (200) binds exemplar domains (201-217) for identity, mint, credit, title, securities, banking, and exchange.

10. The system of claim 1, wherein BEICX/BEISX/BEIGX (191-193) publish settlement proofs to (196-199).

11. The medium of claim 3, wherein policy lists (115-117) are versioned within the compliance inset (112).

12. The system of claim 1, further comprising emergency freeze/recovery (360) keyed to domain policies.

13. The method of claim 2, wherein BEIUSD/BEICNY/BEIEUR are generated only upon successful compliance attestation at (181).

14. The system of claim 1, wherein domain names function as lattice atoms in a honeycomb topology enabling self-healing routes.

15. The method of claim 2, further comprising publishing auditable logs suitable for regulatory reporting.

16. The medium of claim 3, wherein unit calibration (320) maintains inter-currency equivalence across (215), (216), (217).

17. The system of claim 1, wherein originating domain ecosystems from 1999 are enrolled as root nodes.

18. The method of claim 2, wherein sovereign interfaces (196-199) expose open, versioned APIs intended for standards-essential adoption.

19. The system of claim 1, wherein the identity layer (110) anchors DID/PKI keys and cross-chain mappings for settlement finality.

20. The medium of claim 3, wherein circuit breakers in (190) enforce rate limits and thermal thresholds on mint and exchange flows.
